(19) United States
(12) Patent Application Publication
(10) Pub. No.: US 2005/0060210 A1
(43) Pub. Date: Mar. 17, 2005

(54) Rental system, method and apparatus

(76) Inventors: Ronald M. Levi, Calabasas, CA (US); Gregory A. Piccionelli, Los Angeles, CA (US)

Correspondence Address: KOPPEL, JACOBS, PATRICK & HEYBL, 555 ST. CHARLES DRIVE, SUITE 107, THOUSAND OAKS, CA, 91360, US

(21) Appl. No.: 10/936,232

(22) Filed: Sep. 7, 2004

Related U.S. Application Data
(60) Provisional application No. 60/501,966, filed on Sep. 11, 2003.

(51) Int. Cl. G06F 17/60

(52) U.S. Cl. 705/5

(57) ABSTRACT

Embodiments of the present invention are directed to a method, apparatus and system for the rental of items via a computer network. In a preferred embodiment, a consumer joins a membership with the rental provider and selects a rental program, wherein the rental programs are defined by a maximum number of rental items, a predefined rental period and a fee. In preferred embodiments of the invention, the rental system determines whether the user is eligible to receive the requested item, and further, whether the requested item can be distributed to the location specified by the user.

### RELATED APPLICATIONS

This application is related to U.S. Provisional Application, entitled System, Method and Apparatus for Selecting and Exchanging Rental Items, Ser. No. 60/501,966 filed Sep. 11, 2003, and is fully incorporated herein by reference.

### FIELD OF INVENTION

Embodiments of the present invention are directed to the rental of items to consumers. In particular, embodiments of the invention are directed to a system, method and apparatus for renting items to consumers that increases consumer convenience by minimizing constraints imposed by traditional rental systems and further, manages the rental of items in accordance with regulations intended to control the distribution of the item for rent.

### BACKGROUND OF INVENTION

The rental of most items or goods is based upon an agreement to allow use of an item for a given period of time for a fixed, or substantially fixed, amount of money. Typically, in these instances, a consumer selects an item for rental and must indicate, or is assigned, a rental period. To fulfill the agreement, the consumer must return the item at the end of the rental term. If a consumer fails to return the item within the preset period, the consumer is charged a surcharge. In some instances, the surcharge is so excessive that it exceeds or is equivalent to the cost to purchase the item new.

Great inconvenience is often experienced by the consumers in this type of rental arrangement. Indeed, and with specific reference to the video or movie rental business, a consumer's behavior must conform to the rules or expectations of the rental business. For example, to rent a video, a consumer must visit the video store location. Once at the location, the consumer must select the desired items for rental and pre-pay for the rental. The rental periods are preset by the store and can vary from item to item. For example, in some instances, the rental period will vary depending upon whether the selection is a new title or an older title.

Although the above described system has been in operation for a long period of time, it presents several problems. For example, since the rental periods can vary depending upon the type of title being rented, if a consumer selects a new title and an older title, the consumer must remember that the return deadline for the selected items varies; namely, that because of greater demand for the newer title, the rental period set for the newer title is often shorter than the rental period for the older title. Thus, the consumer may be forced to watch the selections in a particular order to accommodate the shorter rental period and further, a consumer may be required to travel to the video store multiple times to return the rented items to optimize the rental period. If the consumer decides to return the item late, the consumer is penalized with an additional fee. To avoid these problems, a consumer may decide to forego one of the rentals, thereby reducing the monies earned by the store, or to view the selections in a particular order regardless of the user's preference. Additionally, as only items currently in stock or inventory can be rented, if an item is not available, the consumer must return to the store, sometimes several times, to rent the out-of-inventory item.

In addition to the above, if the items being rented are regulated in some manner, for example, by law or agreement, a consumer may be required to present identification, and further may be required to select the available regulated items in a predesignated or restricted area, wherein the designated area is set apart from the remaining selection of rental items. Thus, consumers desiring to rent regulated items lose the privacy of their decision in that they are directed to a separate location to find the regulated items, and thus, the consumer can be seen and identified by other consumers in the store to be accessing the restricted area. Further still, as most stores do not have a separate location for paying for these rentals, the actual item selected may be identified by other consumers. In some instances, consumers may prefer anonymity regarding their selections.

Although some on-line systems have been developed that alleviate some of the above-referenced problems, these systems fail to address other issues. For instance, some on-line rental systems provide for the automatic shipment of additional items to consumers upon the return of other rented items without regard for the nature of the item, the location of use of the rented item, location of the user or age of the user. This presents a problem if a rental item or its use is regulated or otherwise restricted, such as a restriction limiting the geographic distribution of the item or limiting the availability to a certain class of consumers. Shipping regulated items in this manner can be violative of numerous laws, or potentially some restrictions appurtenant to the item due to an agreement, such as a licensing agreement restricting territorial distribution.

A need in the industry exists for a system and method for renting items which eliminates the need for the consumer to repeatedly travel to the store or the facility storing the item for the purpose of renting the item. A further need exists for a system that is convenient for the consumer to use and provides privacy to the consumer regarding selections of items to rent. A still further need exists for a rental system that differentiates whether the item is regulated and further manages the distribution of the items in accordance with any restrictions limiting the distribution of the items.

### SUMMARY OF THE DISCLOSURE

Embodiments of the present invention are directed to a method, apparatus and system for the rental of items via a computer network. In preferred embodiments of the rental system, the system comprises an inventory management system, a regulatory management system, and a delivery system. Prior to access by any user, the rental system is populated with inventory rental items via inputting information pertaining to each item into the inventory management system including both identifying information and regulatory information. The regulatory information identifies restrictions or requirements associated with the distribution of the item, including compliance with local or federal laws, regulations relating to foreign countries and restrictions placed on items due to agreements. The regulatory management system utilizes the regulatory information to determine whether an item can be distributed to a particular user at a particular location. If the regulatory restrictions placed upon an item have been met, the delivery system delivers the item to the user. If there are no regulatory restrictions on the item, the item is immediately delivered to the user.

In a preferred embodiment, a consumer joins a membership with a rental provider and selects a rental program, wherein the rental programs are defined by a maximum number of rental items, a predefined rental period and a fee. In preferred embodiments, the rental provider charges the predefined fee for the preset rental period which allows the user to retain up to the predefined maximum number of items (such as videos) during this preset period of time. The specific items in the user's possession are not limited to the initial selection during the rental period, but rather, the only limitation is the maximum number of items in a user's possession at a given time during this rental period.

Once a user has selected a rental program the user can select items for immediate rental up to the maximum number of rental item for the selected rental period. Additionally, the user can identify a first set of items to rent, wherein the first set of items represents a listing of all of the items that the user would like to rent. In some preferred embodiments, the user can create a second set of selected items, wherein the second set can be a subset of the first set of items.

When the user is ready to select the initial items to rent, or subsequent items to rent, the user can review the first set or second set of previously selected items. Only available items can be selected for immediate delivery.

After the user has selected an item, the availability of the item will be re-verified by the rental provider. Once the selection is re-verified as available, the selected items are processed for shipping to the user. Processing of the items includes verification of compliance with regulations, if any, placed upon the item for rental. Upon receipt of the returned items, the rental provider notifies the user of the available number of rentals the user can select. The user can then select the next set of items for rental up to the maximum number of rental items defined by the user's selected rental period.

A feature of preferred embodiments of the invention is the compliance manager. An advantage to this feature is that the system can comply with use or distribution restrictions appurtenant to the item. A further advantage is that regulated items can be included in the system.

A further feature of preferred embodiments of the invention is the non-dependency on the specific item rented as opposed to the number of items rented. An advantage to this feature is that the user can return the items in the order defined by the user.

The above and other advantages of embodiments of this invention will be apparent from the following more detailed description when taken in conjunction with the accompanying drawings. It is intended that the above advantages can be achieved separately by different aspects of the invention and that additional advantages of this invention will involve various combinations of the above independent advantages such that synergistic benefits may be obtained from combined techniques.

### BRIEF DESCRIPTION OF THE DRAWINGS

The detailed description of embodiments of the invention will be made with reference to the accompanying drawings, wherein like numerals designate corresponding parts in the figures.

FIG. 1 is a rental system in accordance with preferred embodiments of the invention.

FIG. 2 is a method of renting items in accordance with a preferred embodiment of the invention.

FIG. 3 is a rental system in accordance with the preferred embodiment of FIG. 1.

FIG. 4 is the rental system in accordance with the preferred embodiment of FIG. 3.

FIG. 5 is a block diagram depicting a method of renting items in accordance with a preferred embodiment of the invention.

FIG. 6 is a block diagram illustrating an exemplar of the restrictions and associated databases in accordance with preferred embodiments of the invention.

### DETAILED DESCRIPTION OF PREFERRED EMBODIMENTS

Embodiments of the present invention are directed to a system, method and apparatus for renting items to consumers. Although it is to be understood that items can include any type of inventory item which a consumer can rent, including but not limited to, books, equipment, videos, movies, and music, the described embodiments will be directed to video tape rental, wherein ‘video tape’ is intended as an exemplary medium and is not intended to limit the medium, which can include, but is not limited to, CD-Roms, DVDs, cassettes, audio tapes and video tapes.

Hardware Environment:

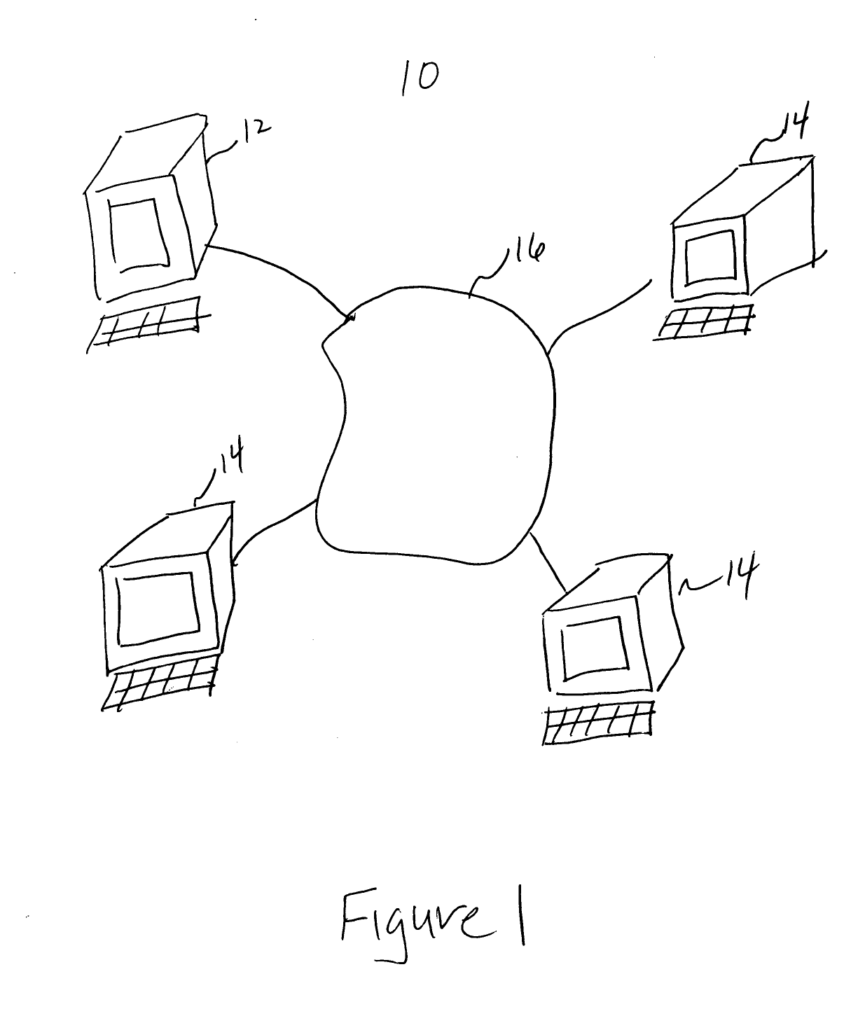

Preferred embodiments of the instant invention operate in accordance with a plurality of networked computers, such as, for example, a user or subscriber computer and a provider computer which are coupled together on a communications network, such as, for example, the Internet or a wide area network. FIG. 1 depicts a network system 10 that operates in accordance with preferred embodiments of the invention. In preferred embodiments, the network system 10 includes a server computer 12, or a provider computer, and a user computer 14, wherein the provider computer 12 and the user computer 14 are in electronic communication with each other via a communication link 16.

In some preferred embodiments, the network system 10 includes a plurality of either the provider computer 12, the user computer 14 or any combination thereof. The provider computer 12, or server, may comprise any suitable network device capable of providing content (data representing text, hypertext, photographs, graphics video and/or audio) for communication over the network. In preferred embodiments, the provider computer 12 comprises a programmable processor capable of operating in accordance with programs stored on one or more computer readable media (for example, but not limited to, floppy disks, hard disks, random access memory RAM, CD-ROM), to provide content for communication to a user computer 14. The provider computer 12 may comprise, for example, but is not limited to, a personal computer, a mainframe computer, network computer, portable computer, personal digital assistant (such as, a 3Com Palm Pilot), cellular telephones and the like. The provider computer 12 may include one or more internal data storage devices (not shown) for storing content for communication to a user computer 14. Alternatively, or in addition, the provider computer 12 may be coupled to an external data storage device, computer or other means (not shown) from which the provider computer 12 may obtain content for communication to the subscriber computer 14. In one embodiment, the external device may comprise a further network device coupled in the network 16. The provider computer 12 is controlled by suitable software to provide the requested content to the requesting user computer 14, provided that various criteria are met.

In a preferred wide area network environment, such as the Internet environment, the provider computer 12 is controlled by suitable software to respond to a valid request for content by providing (or downloading) data to the user computer 14 from which the request was made. It will be understood by those skilled in the art that this process involves communications through suitable servers, routers and other components, as is dictated by the particular network environment.

The provider computer 12 operates with a persistent storage means (not shown), for example, one or more of the fixed and/or removable data storage devices and/or data communications devices connected to the computer. The communication link 16 may include a public network, such as the Internet, a local area network, or any other suitable communications connection, hardwired, wireless, or a hybrid thereof.

The user computer 14 may comprise any suitable network device capable of communicating with other network devices in the network system. In preferred embodiments, each user computer comprises a programmable processor capable of operating in accordance with programs stored on one or more computer readable media (for example, but not limited to floppy disc, hard disc, computer network, random access memory (RAM), CD Rom, or the like), a display device for providing a user-perceivable display (for example, but not limited to visual displays, such as cathode ray tube CRT displays, light-emitting-diode LED or liquid-crystal-diode LCD displays, plasma displays or the like, audio displays or tactile displays), and a user input device (for example, but not limited to, a keyboard, mouse, microphone, or the like). In one preferred embodiment, at least one subscriber computer comprises a personal computer system having a CRT display, a keyboard and a mouse user-input device.

The user computer 14 is controlled by suitable software, including network communication and browser software to allow a user to request, receive and display information (or content) from or through a provider computer 12 on the network system 10. The user computer 14 operates in accordance with programs stored on a readable medium, including, but not limited to, floppy disks, hard disks, RAM and CD-ROM. The user computer 14 is any means capable of communicating with the provider computer 12, including, but not limited, to personal computers, kiosks and ATM-type machines. The user computer 14 accesses the provider computer 12 via the wide area network or through some other remote access, such as, for example, by telephone, facsimile, personal digital assistant, pulse code system, web TV, or any other device or method that communicates alpha numeric data with a server.

### General Description of Preferred Embodiments

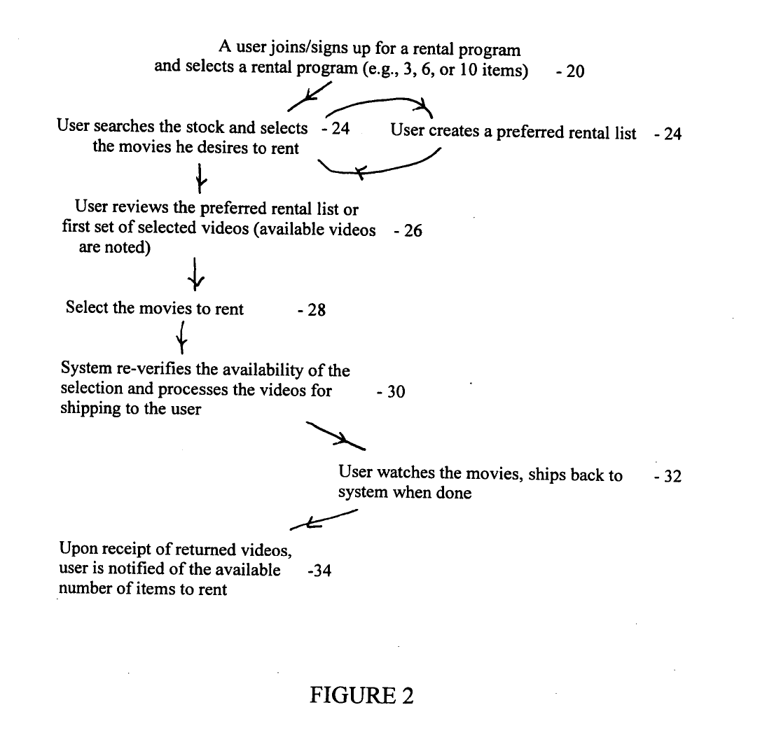

Embodiments of the present invention are directed to a method, apparatus and system for the rental of items. With reference to FIG. 2, in a preferred embodiment for the rental of items, a consumer, or user, joins a membership or signs up with the rental provider and selects a rental program 20. Each rental program is defined by a maximum number of rental items, a predefined rental period and a fee. In preferred embodiments, the rental provider charges the predefined fee for the preset rental period, wherein the user is allowed to retain up to the predefined maximum number of items (such as videos) during this preset period of time. The fee for the rental program increases as the number of permitted rental items increases. In preferred embodiments, the rental period is monthly. In one preferred embodiment, the rental programs permit a user to possess up to a maximum of three (3), six (6) or ten (10) videos during a one month period. Thus, for example, if a user selects the three (3) item program, a user can possess up to three (3) videos at all times during the month for a fixed fee. It is to be understood that the specific items in the user's possession are not limited to the initial selection, rather, the only limitation is the maximum number of items in a user's possession at a given time during the rental period. Thus, if a user selects the maximum number of items for rent, and returns one of the items during the rental period, a replacement item can be selected during the preset rental period with no further fee. If the user extends the membership an additional rental period, for example, an additional month, the user can retain the items previously rented in the new rental period. In this regard, the user's use of the items are not limited to the original rental period, but rather, can be indefinite as long as the rental period is renewed by the user.

Once a user has selected a rental program, to expedite the rental process, the user reviews a listing of videos potentially available to the user for rent, or searches the inventory by name, publisher, actor or any other suitable identifier, and identifies a first set of selected videos, wherein the first set of selected videos represents the listing of videos the user desires to rent 22. In addition, in some preferred embodiments, the user can create a second set of selected videos, wherein the second set can be a subset of the first set of selected videos 24 (or the entire list in the first set), and represents a preferred rental list, that is, those videos from the first set of selected videos that a user is particularly interested in viewing.

If this is the initial selection process, the user can select the initial videos that the user desires to immediately rent while simultaneously identifying the videos for the first set of selected videos or while identifying the second set, or preferred rental list. Otherwise, the user can make a rental selection at any time after joining the program.

When the user is ready to select videos to rent, for ease of selection, the user reviews the preferred rental list and/or, if desired, the user can review the entire first set of selected videos 26. As only the videos in stock are available for rental, the user selects at least one video for rental from those items that are currently available 28. Videos that are currently available will be highlighted or otherwise noted as available, thereby avoiding a request for an out of stock item. After the user has selected an item, the availability of the item will be re-verified by the rental provider. Once the selection is re-verified as available, the selected videos are processed for shipping to the user 30. Once the user receives the videos, the user views the videos and returns them to the rental provider when the user has completed viewing the video 32. Upon receipt of the returned videos, the rental provider notifies the user of the receipt of the videos and the available number of rentals the user can select 34. The user then reviews the preferred rental list 26 and identifies the next set of videos or video that the user desires to view 26, 28, and/or searches the entire inventory 22.

In preferred embodiments, the user is not restrained by dissimilar rental periods for each item. Thus, the user can view the videos in any desired order, in any time frame, and can view each video as many times as the user desires. Further, a user can return any or all of the videos at a given time, and can return the videos in any order. Thus, if a user desires to review a particular video, the user can return the remaining selections and retain the video the user wants to view again. If the user returns less than the number of videos originally rented, the user is notified of the number of available rentals. For example, if a user has a three (3) video program, assuming an original rental of three (3) videos, upon return of two (2) rented videos, the rental provider will notify the user that he can rent up to two (2) additional videos such that the total number of videos potentially in his possession does not exceed three (3).

In preferred embodiments, the number of videos a user can possess at any given time can be changed by any suitable means, including, but not limited to, a formal request to change the rental program, a request to rent more videos than permitted under the current program, or by any combination of suitable actions. In instances wherein the user requests more videos than currently allowed by the selected rental program, in some preferred embodiments, the maximum number of allowable videos would automatically increase to the next highest rental program, and the user would be charged for a higher rental program.

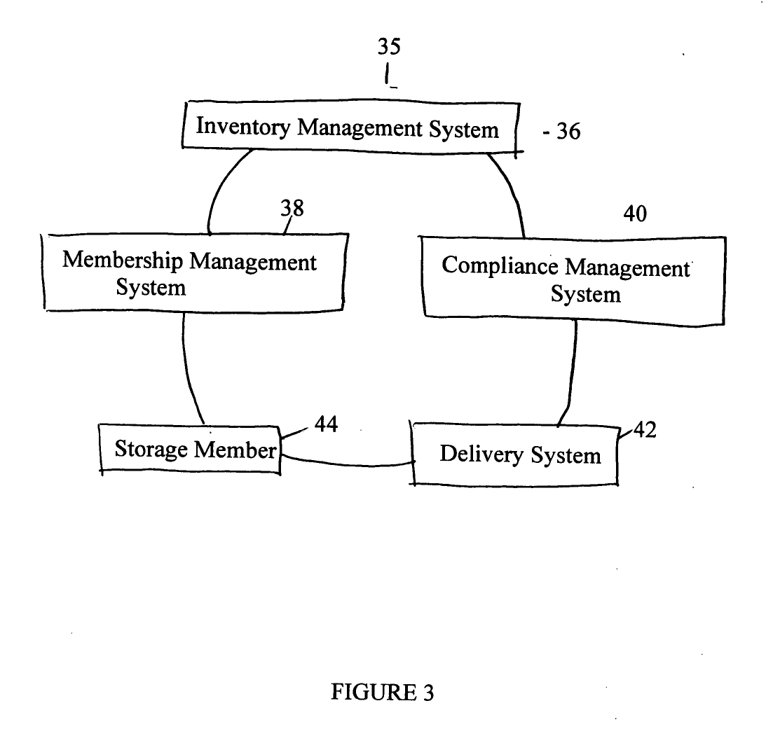

With reference to FIG. 3, preferred embodiments of the rental system 35 comprises, an inventory management system 36, a membership management system 38, a compliance or regulatory management system 40, a delivery system 42 and a storage member 44. Prior to access by any user, the rental system is populated with inventory rental items that are subsequently offered to consumers for rent.

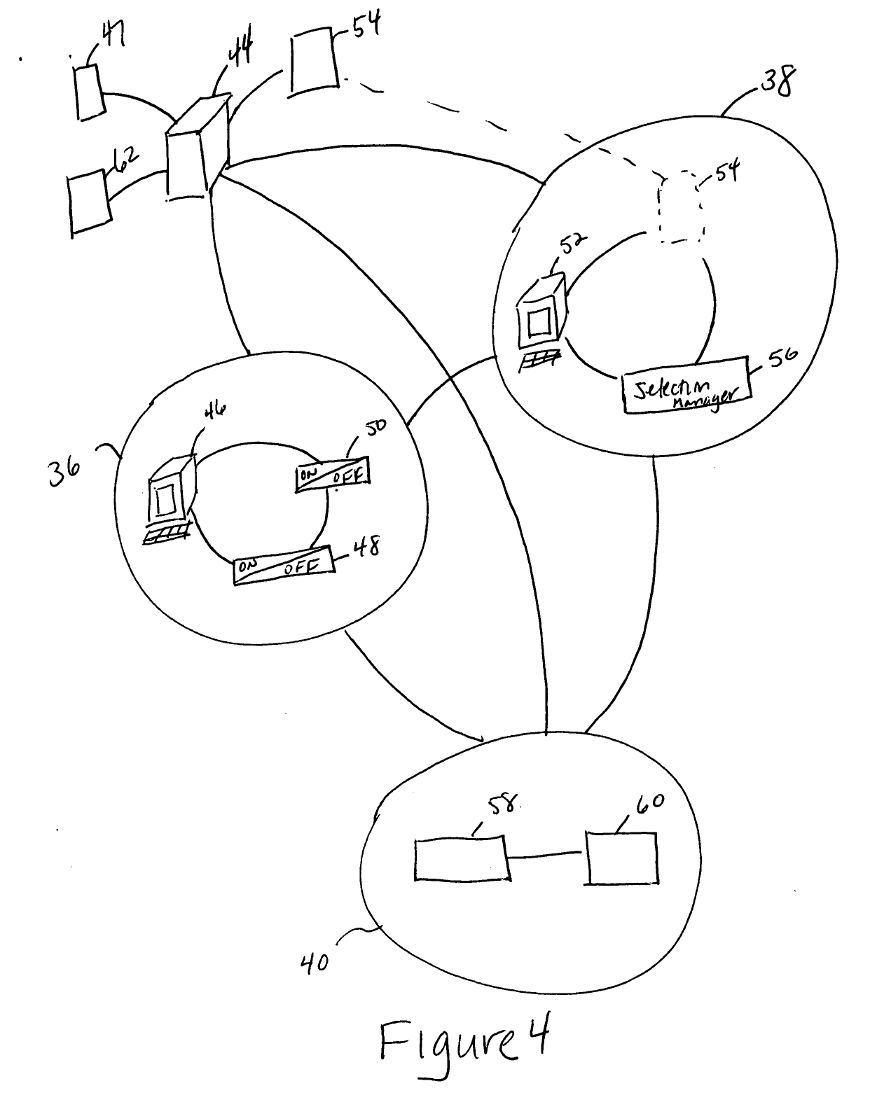

The inventory management system 36 is configured to receive and store information regarding available items for rent. With reference to FIG. 4, the inventory management system comprises an inventory receiving member 46, an availability notification means or flag 48 and a restriction notification means or flag 50. The inventory receiving member 46 is an input interface that collects relevant information about each item entered into the system and stores the information in an inventory database 47. The type of information collected for each item comprises identifying information and regulatory information. Identifying information collected for each item, includes, but is not limited to, an identifier, such as a title or name; a description of the item; an image of the item; and, if available, a promotional clip or video for the item. In preferred embodiments, wherein the rental item is a video or movie, the inventory receiving member further collects, some or all of the following: the name of the movie, the name of the director, the name of the producer, the name(s) of the featured actor(s), a description of the movie, and, if available, a promotional advertisement or trailer of the movie.

In addition to the identifying information, regulatory information is collected. Regulatory information includes information directed to requirements for compliance with local or federal laws, regulations of foreign countries and restrictions placed on items due to agreements, such as, licensing agreements. For example, a movie may have a territorial distribution restriction pursuant to a copyright licensing agreement, wherein the licensee is only entitled to distribute within Europe. Further, overall restrictions about an item, for example, delivery restrictions to particular zip codes or states can be entered or a link to a third party database, such as, a restricted zip code database can be included. In this regard, general restrictions placed upon the item can be linked to the item.

In preferred embodiments, information is entered into the inventory management system 36 via user interface pages, wherein the information is input via input boxes. However, information can be inputted by any suitable means, including, but not limited to, pull-down menus, speech recognition means, telephone, personal digital assistant, and web TV.

The information received by the inventory receiving member 46 is stored in the storage member 44. The storage member 44 is any suitable storage means such as, a permanent storage disk. The storage member can be externally coupled to the rental provider server or internal to the rental provider server, or can include transportable medium, including but not limited to a disk, CD ROM or DVD. In preferred embodiments, multiple storage members can be used.

The availability flag 48 is an indicator that is set ‘on’ or ‘off’, wherein the ‘on’ position indicates that the item is available and ‘off’ indicates that the item is not available. If the availability flag is on, the item can be selected by the user for rental. If the availability flag is off, the item cannot be selected by the user for rental. It is to be understood that any manner of indicating the availability of an item is suitable.

The availability flag 48 is turned on when an item is initially entered into the inventory database 47. Upon the rental of an item, the availability flag is turned off such that the system identifies that the item is not in stock. If the system retains more than one copy of a specific item, the availability flag is not turned off until the last item is rented. Instead, in some preferred embodiments, a counter corresponding to the number of copies is decreased when a multi-stocked item is rented. Upon rental of the final copy, the availability flag is turned off.

The regulatory flag 50 is an indicator that is set ‘on’ or ‘off’, wherein the ‘on’ position indicates that the item is regulated and ‘off’ indicates that the item is not regulated. The regulatory flag 50 is set when an item is initially entered into the inventory management system 36. If the regulatory flag is set ‘on’, as discussed below, if the regulated item is selected, the rental system transmits notification to the compliance management system 40. If an item is initially regulated, but subsequently becomes unregulated, the regulatory flag setting can be changed to reflect the new status. Similarly, the flag for a non-regulated item can be changed if that item is subsequently regulated. It is to be understood that any manner of identifying whether an item is regulated is suitable.

The rental system is accessible by the user computer 14 via a series of user interface pages, such as, web pages. The interface pages couples the user to the membership management system 38 via the user computer 14. With reference again to FIG. 4, the membership management system 36 comprises a user interface 52, a membership database 54, and a selection manager 56. In preferred embodiments, the user interface is a series of user interface pages, such as web pages, wherein transaction information is input via input boxes, although information can be input by any suitable means, including, but not limited to, pull-down menus, speech recognition means, telephone, personal digital assistant, and web TV.

The user interface collects user information, including, but not limited to, a name, address, age or birth date, username and password. In addition to identifying user information, the user interface collects payment information, including, but not limited to, credit card information, direct payment information, or checking information. It is to be understood, that depending upon a user's designated address, the type of payment method may be limited by law or by preference of the rental provider. For instance, some restrictions may be placed upon users in foreign countries, such as, a limitation as to the acceptance of credit cards as payment means. Further still, some transactions may require a specific type of payment method. For instance, some countries may only allow payment by check or direct debit payment. In preferred embodiments, all types of payment information are initially collected to avoid interruption of a delivery to the user in the event that a specific item requires a specific payment modality. In some preferred embodiments, the user can enter user restrictions that govern, for example, the amount of money spent per month, the type of item or content to be offered, displayed or delivered to the user, time limits on membership, payment modalities, delivery destination(s), and any other suitable user restrictions. In this regard, a user can control the use of the system by other users, including minors. Once the user is satisfied with the input information, the user information, payment information and user restrictions, if any, are stored in the membership database 54 in the storage member 44.

If a user has placed a restriction on the type of item to be displayed, offered or delivered, items contained in the inventory database 47 meeting the user's restrictions can be associated with the user and the identification of these items may be stored in the membership database 54. In this regard, these items may not be offered, displayed or shipped to the user. In some preferred embodiments, an item may be displayed so that the user is aware of its availability, but the item cannot be shipped until the user changes the restriction or provides a waiver for the particular item. A waiver could be made by any suitable means, including, but not limited to, a telephone call or identification of the user and a written request to override the restriction.

In addition to searching the inventory database 47 for items matching the user's restrictions, in some preferred embodiments, the system reviews the inventory database 47 to determine whether any items are restricted based on user information, for example, the user's entered zip code or age. The identification of these noted items may also be stored in the membership database 54 in association with the user.

To expedite the rental process, the selection manager is software that is configured to access the storage member 44 to allow the user to select at least one set of items for rental. As discussed above, in one preferred embodiment, the user selects a first set of items and a second set of items for rent, wherein the first set of items is selected from the entire inventory and the second set is selected from the first set of items and forms a subset of the first set of items. The second set represents the user's ‘preferred list’. The user can select the first set and second set by any suitable means, including but not limited to, highlighting selections, checking a box next to a selection, and creating a list of selected items. The selection of the first set of items and second set of items is stored in the membership database 54 in association with the user.

In one preferred embodiment, the selection manager 56 comprises a search engine, wherein the user can search the inventory using any suitable identifier, including, but not limited to, item name, publisher, director, and actor. Additionally, a user can visually peruse the inventory list. The practicality of this option is dictated, in part, by the size of the inventory. The user can select available and non-available items at this time, although the non-available items cannot be currently shipped, only placed on the selection list.

The compliance, or regulatory, management system 40 collects and stores information regarding any regulations, restrictions or compliance requirements for a particular item. In some preferred embodiments, the compliance management system is software that is configured to determine whether an item can be shipped to a specific location or a specific user, in part, by comparing input user data with known data. The compliance management system operates in conjunction with third party databases and the databases of the rental system to ascertain the relevant information regarding compliance requirements for a regulated item.

The compliance system 40 comprises a compliance manager 58 and a reporting means 60. As discussed above, information regarding the item to be offered for rent is input via the inventory receiving member 46. When regulatory information is entered via the receiving member, the regulatory flag is turned ‘on’. The regulatory information is stored in a regulatory database 62 in the storage member 44, although in some preferred embodiments, the information can be stored in the inventory database 47 in association with the specific item or the membership database 54. Additionally, third party information sources which are necessary to determine whether the rental of the requested item to the user complies with the regulatory restrictions are identified in association with the item such that these sources can be reviewed prior to the shipment of the item in a particular instance. For example, the department of motor vehicles (“DMV”) databases can be used to determine a person's age. The identification of the third party sources can be stored in the regulatory database and/or inventory database in association with the item.

The compliance manager 58 is a computer program configured to assess whether a particular item can be shipped to a particular user and to a particular location. Upon receipt of information regarding the proposed shipping destination, the compliance manager reviews a set of predefined sources, including third party sources, and compares the input information, both the regulatory and identifying information, with the information in the identified sources. The sources include, but are not limited to, the membership database, the inventory database, storage member, a license database, and third party databases, wherein third party databases include but are not limited to, licensing databases, prohibited zip code databases, prohibited mailing lists such as 18 U.S.C. §§1735 and 1737 (Federal Sexually Oriented Advertisement Mailing Prohibitions) and 39 U.S.C. §3008 et seq. (Pandering Advertisements Regulations), department of motor vehicle “DMV”), and credit card databases. For example, in preferred embodiments, upon identification of a regulated item, the compliance manager automatically compares the shipping address to the zip code database and the restricted database to verify whether the shipping address is a location where the shipment of the item is prohibited. Based upon the comparison of the input information and the various databases, a determination is made as to whether the selected item can be shipped to the designated location.

In addition to verifying whether an item can be shipped to a specific location, in preferred embodiments the compliance manager assesses whether a member is eligible to receive the requested item, that is, whether the user is an appropriate member of a class of users allowed to receive the item. That is, the user is not a member of a restricted class. Thus, in some instances, even if the item can be legitimately shipped to a particular location, the user may not be an eligible user to receive the item and the request to ship would be denied. For example, in some preferred embodiments, the compliance manager determines whether the user is, minimally, the age of majority in the geophysical location identified by the address. In some preferred embodiments, verification of the user's age is performed by comparing input information to information contained in known third party databases, such as, the DMV database, a credit card database or financial institution database. For example, a credit card number can be compared to a third party credit card database that identifies the owner of the card, including the owner's birth date. The database, or databases, that can be used to verify particular information is identified upon input of the user's identifying and payment information. In instances wherein further information is required for verification, the compliance manager can prompt the user for additional information, including, but not limited to, a driver's license number, social security number, an age verification (“AVS”) password, or the user's declaration attesting to age, for example, a digital certificate. Other means of verifying a user's age include, but are not limited to, use of a video camera to show a driver's license, and various biometrics means, such as, an eye scan or thumb print.

Once the determination has been made regarding whether the item can be shipped, and whether it can be shipped to the requesting user, the reporting means 60 notifies the user and the delivery system 42 as to whether the shipment request, in its entirety, can be fulfilled. The reporting means 60 can be any suitable means for transmitting a notification, including, but not limited to, a computer generated notification, a telephone operator, electronic mail, cell phone messaging, and instant-to-fast notification means.

With reference again to FIG. 3, the delivery system 42 is the means by which the requested items are delivered to the user, such as for example, a fulfillment house or overnight service. In preferred embodiments, the delivery system receives a request for the shipment of a selection of items. If no restriction is placed on the items, that is, the regulatory flag is set on ‘off’ for each item, the items are collected from inventory by suitable means and forwarded to the shipping address provided by the user. If some of the items are restricted, the delivery system collects only the non-regulated items and waits to receive notification from the compliance manager as to whether the remaining items can be shipped. If the delivery system does not receive authorization to ship a particular item, the delivery system does not include that item in the shipment.

In some preferred embodiments, the actual shipment of the items is performed by a third party that receives notification from the delivery system. In this instance, all of the issues regarding regulated items are resolved prior to the request for shipment being transmitted to the third party. Thus, if some of the items cannot be shipped, the identification of those items will not be included in the notification to the third party shipper. In some embodiments, the rental system utilizes a network of third parties capable of delivering selected items. When a user selects items for rent, the third party closest to the user's location can be selected to deliver some or all of the requested items. Further still, in some embodiments, the rental system may not have any of the items in stock, but rather has a virtual inventory, wherein the rental system has a listing of the inventories for each third party, and simply requests delivery of the items from the third party having the items in stock. Thus, a user's request may be fulfilled from more than one third party. In embodiments wherein the fulfillment is accomplished via multiple third parties, all of the items may be delivered to a single shipment location prior to sending them to the user.

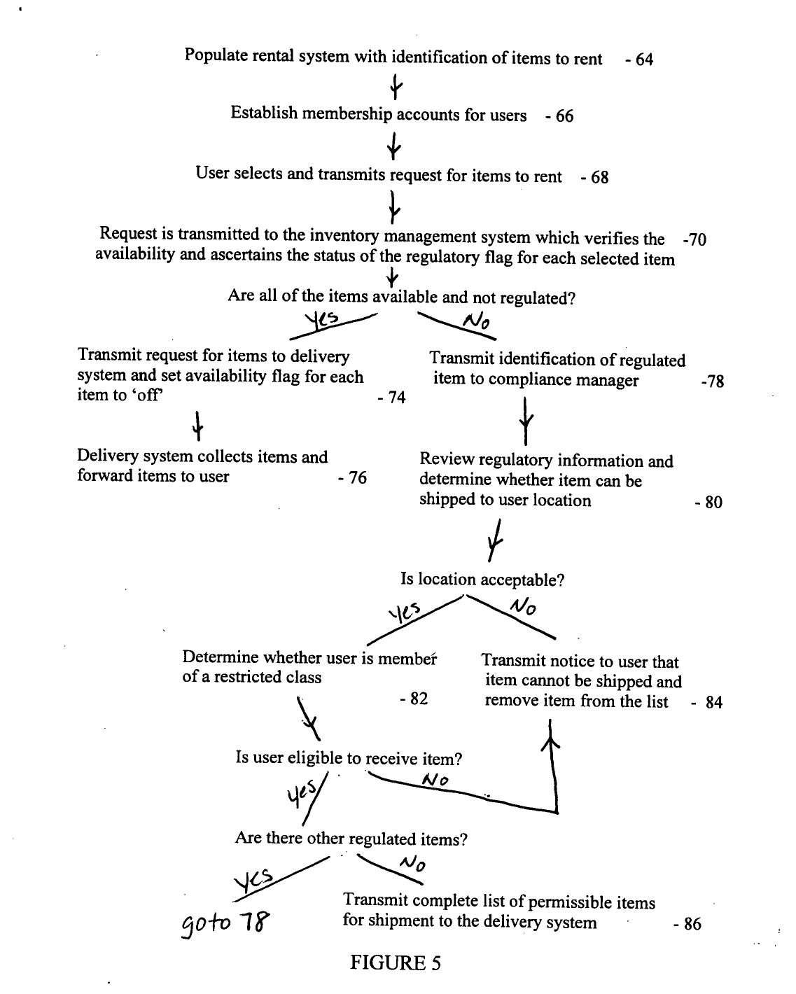

In operation, and with reference to FIG. 5, prior to access of the rental system by users, the inventory management system is populated with items for rent 64, wherein descriptive information regarding the item and restrictions on the rental of the item is input and stored in a database. Once the items have been input, and the inventory has been established, the rental system can establish membership accounts for users 66.

A user desiring to use the rental system, accesses the user interface of the rental system to establish a membership. The user inputs user information and selects the rental program appropriate for the user. All of the user information is stored in the membership database.

Once the user's membership has been established, the user can create a listing of items to rent, which includes future rental selections. After the user has selected the items the user desires to ultimately rent and if desired, has created a subset of preferences from that list, the user selects at least one, but can select up to the number of items the user is entitled to rent as established by the selected rental program 68. The request to rent the identified items is transmitted to the inventory management system. Upon receipt, the availability of each item is verified and the status of the regulatory flag is ascertained 70. If every item is available and none are flagged as a regulated item, the request for the items is transmitted to the delivery system and the availability flag is set to ‘off’ for each item 74. Upon receipt of the list of items for delivery, the delivery system collects the requested items and forwards them to the identified mailing address 76.

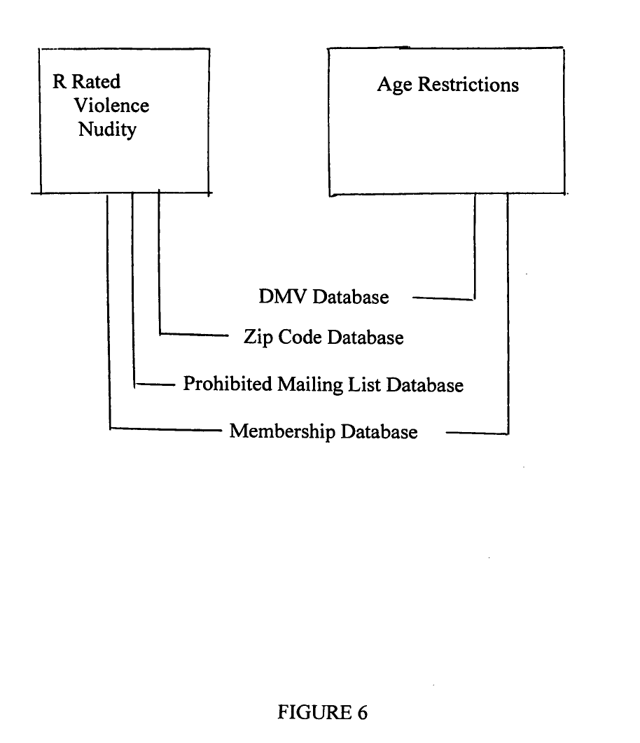

If at least one item is identified as a regulated item, the inventory management system transmits the identification of the item to the compliance manager 78. The compliance manager reviews various input information regarding the user and the item. Upon review of the user information, the compliance manager ascertains the physical mailing location designated for the user and the user's age. The compliance manager then reviews the regulatory information for the item and determines whether the item can be shipped to the user location 80. In some preferred embodiments, the compliance manager reviews pre-designated databases pertaining to the nature of the item as it pertains to the shipping location. For example, with reference to FIG. 6, if a user has designated a video containing violence which is rated R, the compliance manager could review a prohibited mailing list database, wherein the prohibited mailing list is a listing of addresses where content of this nature may not be delivered. In some instances, other databases which may be pertinent to the nature of the item will additionally be reviewed. For example, if the user has selected an adult content video, in addition to the prohibited mailing list, the compliance manager will also review databases that pertain to various regulations of this material, such as, the recordkeeping requirements governed under 18 U.S.C. §2257, and a listing of acceptable locations in which to transmit the particular content such as a prohibited zip code list, for example, to accommodate the sender's concerns regarding the contemporary community standards of the locations into which the item would be sent. If it is ascertained that the selected content can be forwarded to the shipping location designated by the user, the compliance manager next verifies that the user is of legal majority, for example, eighteen (18) years old 82. If the user is not eligible to receive this material, the compliance manager transmits a notice to the user and removes the item from the requested list 84. The user is then invited to submit an additional request. The system then stores the user's age information and does not repeat the analysis of whether the user is eligible to receive selections which are restricted for the user's age. This process is continued for all regulated items on the list. If there are other regulated items on the list, the identification of the next item is transmitted to the compliance manager 78. In some preferred embodiments, once the final list of permissible items for the user is established, the list is transmitted to the delivery system 86. Upon receipt of the verified list of items, the delivery system collects the requested items and forwards them to the identified mailing address 76.

Once the items are received the user can review the items as desired. Further, the user can return any or all of the items at any time. Upon return of an item, the inventory management system resets the availability flag to ‘on’. Further a notification is transmitted to the user regarding the number of returned items, and the number of available items that can be rented. Notification to the user can occur by any suitable means, including, notification to the user via cellular telephone, electronic mail, and telephone. In some preferred embodiments, the listing of the user's second set of selected items is transmitted to the user with the notification, wherein the user can select up to the number of items that can be rented. For example, an electronic mail message, including the user's second alternative of selected items can be forwarded to the user. The user can reply to the electronic mail and select new items to rent. The selection can be immediately transmitted back to the rental system for processing. If no selection is made in response to the notification, the user can log back into the system at a later time to make a selection.

It is to be understood that many variations of the above-described embodiments can be made and the above is not intended to limit the invention. Indeed, in some embodiments, a user's age and location may be verified prior to providing details regarding the item for rent For example, a user interested in a particular rental item may request viewing of the promotional video. If the item is regulated, the promotional clip may be unsuitable for transmission in certain geographical areas, or to a user because of a restricted mailing list. Thus, verification of the location of the user, and the age of the user would be required prior to responding to the user's request. In addition to the means described above, verification of the location of a user can be made by any suitable means, including, but not limited to, geophysical means as described in U.S. Pat. No. 6,154,172 to Piccionelli et al. and U.S. application Ser. No. 09/812,296, published Feb. 21, 2002, an ISP look-up to verify computer location.

Further still, a user may be pre-qualified prior to the allowance of any selection of items. If a user is age appropriate or resident in non-restricted locations, the user may be allowed to review all of the inventory, wherein a user that is not age appropriate could be restricted from reviewing a portion of the inventory. In this instance, only portions of the inventory would be made available to the user. For example, a tape that cannot be distributed in Germany may not be included in the inventory list displayed or made visually available for the user residing in Germany. Additionally, in some preferred embodiments, the system automatically reviews a pre-selected set of third party sources if an item is regulated. In this manner, there is no need to identify third party sources for each regulated item individually. While the invention has been particularly shown and described with reference to preferred embodiments thereof, it will be understood by those skilled in the art that various other changes in the form and details may be made therein without departing from the spirit and scope of the invention.

1. A method for renting items to users via a computer network having a provider computer and a user computer, wherein the provider computer and the user computer are in communication therebetween, the method comprising:
receiving, from the user computer, a request for at least one selected item that the user desires to rent;
verifying the availability of the selected item;
identifying whether the selected item is regulated; and
if the item is available and not regulated, delivering the item to the user at a user defined shipping destination;
if the item is available and regulated, determining whether the item can be delivered to the user.

2. A method as claimed in claim 1, wherein determining whether the item can be delivered comprises:
comparing the user defined destination to information contained in at least one database containing geophysical location information.

3. A method as claimed in claim 1, wherein determining whether the item can be delivered comprises:
comparing user registration information to information contained in at least one database containing geophysical locations, financial records, or public records.

4. A method as claimed in claim 2, wherein the database is a prohibitive mailing list.

5. A method as claimed in claim 1, wherein identifying whether the item is regulated comprises:
reviewing a regulatory status indicator, wherein the regulatory status indicator identifies whether the item is regulated.

6. A method as claimed in claim 1, further comprising:
transmitting a notification regarding the shipping status of the requested item.

7. A method as claimed in claim 1, further comprising:
revising information pertaining to the availability of the item.

8. A method as claimed in claim 1, further comprising:
receiving, at the provider computer, notification that the item was returned by the user; and
transmitting, from the provider computer to the user computer, notification that the user can select another item for rent.

9. A method as claimed in claim 1, further comprising;
receiving registration information on the provider computer from the user computer, the registration information including user identification information; and
receiving, from the user computer, a rental program selection, wherein the rental program identifies a rental period, a maximum number of items that the user can possess during each rental period and a fee for the selected rental program; and
receiving, from the user computer, identification of a first set of items that the user desires to rent.

10. A method as claimed in claim 9, further comprising:
receiving, from the user computer, a second set of items that the user desires to rent, wherein the second set of items is a subset of the first set of items.

11. A method as claimed in claim 1, wherein determining whether the item can be delivered comprises:
determining whether the user defined destination restricts the delivery of the selected item.

12. A method as claimed in claim 1, wherein determining whether the item can be delivered comprises:
determining whether the user is a member of a restricted class.

13. An apparatus for renting items to users via a computer network having a provider computer and a user computer, wherein the provider computer and the user computer are in communication therebetween, the apparatus comprising:
an inventory management system for receiving and storing information regarding items for rent;
a compliance management system for identifying items that are regulated;
a delivery system for delivering items to a user; and
a storage member; wherein the inventory management system, the compliance management system, the delivery system and the storage member are in electronic communication with each other.

14. An apparatus as claimed in claim 13, further comprising a membership management system for receiving registration information from a user desirous of renting items and for providing a selection of rental programs to the user.

15. An apparatus as claimed in claim 13, wherein the inventory management system further comprises:
an inventory receiving member, wherein the inventory receiving member is configured to receive information regarding each item entered into the inventory management system for rent;
an inventory database, wherein the inventory database is coupled to the inventory receiving member and stores information entered for each item entered into the inventory management system;
an availability flag configured to indicate whether the item is in inventory, the availability flag being associated with each entered item, and
a restriction flag, wherein the restriction flag indicates whether the item is regulated, and wherein information regarding the availability flag and restriction flag are stored in the inventory database in association with each item.

16. An apparatus as claimed in claim 15, wherein the restriction flag comprises an ‘on’ status and ‘off’ status, wherein the ‘on’ status indicates that delivery of the item is regulated, and the ‘off’ status indicates that delivery of the item is not regulated.

17. An apparatus as claimed in claim 13, wherein the compliance management system further comprises:
a compliance manager, wherein the compliance manager determines whether an identified item can be delivered to the user or a location identified by the user; and
a reporting means for notifying the user as to whether the item can be delivered.

18. An apparatus as claimed in claim 13, wherein the compliance management system further comprises:
a regulatory database, wherein information regarding regulations pertaining to an item are stored in association with the identification of the item.

19. An apparatus as claimed in claim 13, wherein predefined sources associated with a particular item are stored in the storage member, wherein the predefined sources contain information for use in determining whether a particular item is compliant with the regulations identified for the item.

20. An apparatus as claimed in claim 19, wherein the compliance manager is configured to compare information in the predefined sources with the user input information.

21. An apparatus for renting items to users via a computer network having a provider computer and a user computer, wherein the provider computer and the user computer are in communication therebetween, the apparatus comprising:
an inventory management system for receiving and storing information regarding items for rent;
a compliance management system for identifying items that are regulated;
a delivery system for delivering items to a user;
a membership management system configured to receive information, wherein at least a portion of the information can be used by the compliance management system to determine whether an item can be delivered to the user; and
a storage member; wherein the inventory management system, the compliance management system, the membership management system, the delivery system and the storage member are in electronic communication with each other.
